(19) United States
(12) Patent Application Publication
(10) Pub. No.: US 2019/0268624 A1
(43) Pub. Date: Aug. 29, 2019

(54) SYSTEM FOR MANAGING CONTENT PLAYBACK

(71) Applicant: CJ CGV CO., LTD., Seoul (KR)

(72) Inventors: Soo Jin KIM, Goyang-si Gyeonggi-do (KR); Wayne OHM, Paju-si Gyeonggi-do (KR)

(21) Appl. No.: 16/345,819

(22) PCT Filed: Nov. 13, 2017
(86) PCT No.: PCT/KR2017/012817

§ 371 Date: Apr. 29, 2019

(30) Foreign Application Priority Data
Dec. 2, 2016 (KR) 10-2016-0163622

(51) Int. Cl. H04N 21/214; H04N 21/414; H04N 21/443; H04N 21/472; H04N 21/262

(52) U.S. Cl. CPC H04N 21/2143; H04N 21/41415; G06Q 30/0241; H04N 21/47217; H04N 21/262; H04N 21/4432

(57) ABSTRACT

Disclosed is a theater management system. The theater management system includes a playback preparation management unit configured to determine a playback preparation state of a digital server provided in each theater for each round and to provide a guide for playback preparation completion if the playback preparation state is a playback preparation incompletion state.

### TECHNICAL FIELD

The present invention relates to a system for managing content playback and, more particularly, to a system for managing content playback, which enables a user who does not have knowledge of projection to perform a projection operation by automatically controlling pieces of equipment included in a theater.

### BACKGROUND ART

In line with the development of the playback technology, a movie produced using a film in the past is digitalized and produced in the thrill of digital movie content. Accordingly, distribution efficiency of movie content has been significantly improved because digital movie content can be transmitted over a network without a need to directly transfer a film to a theater as in the past.

As distribution efficiency of content is improved due to digitalized movie content, the number of theaters in which digital movie content is played back is suddenly increased. A distributor that distributes digital movie content can rapidly distribute digital movie content to a plurality of theaters at the same time.

Although the technology for distributing digital movie content to a plurality of theaters at the same time is advanced, a common manager who does not have knowledge of projection cannot perform a projection operation because projection professional manpower and a manage who contacts customers are separated in a theater. In this case, there is a disadvantage in inefficiency in terms of a manpower operation in a theater.

Accordingly, there is a need for the development of a system which enables a common manage not having knowledge of projection to perform a projection operation for manpower operation efficiency in a theater.

### PRIOR ART DOCUMENT

### Patent Document

(Patent Document 1) Prior Art 1: Korean Patent Application Publication No. 2012-0115668 (Oct. 19, 2012)

### DISCLOSURE

### Technical Problem

The present invention has been made to solve the above problems occurring in the prior art and an object of the present invention is to provide a system for managing content playback, which enables a user not having knowledge of projection to perform a projection operation for manpower operation efficiency in a theater.

Technical objects to be achieved by the present invention are not limited to the aforementioned objects, and those skilled in the art to which the present invention pertains may evidently understand other technological objects from the following description.

### Technical Solution

In accordance with an aspect of the present invention, there is provided a theater management system including a playback preparation management unit configured to determine a playback preparation state of a digital server provided in each theater for each round and to provide a guide for playback preparation completion if the playback preparation state is a playback preparation incompletion state.

The playback preparation management unit may include a determination module configured to determine the playback preparation state depending on whether an element including at least one of a schedule, an SPL, a digital cinema package (DCP) and a key delivery message (KDM) has been distributed to each digital server and a guide providing module configured to provide a guide for the playback preparation completion of a corresponding element if the corresponding element is in the playback preparation incompletion state.

Furthermore, the theater management system may further include a display module configured to display the playback preparation state for the element of each digital server for each round which has determined by the determination module.

The determination module may determine the playback preparation state for the DCP and the SPL using a unique ID, may determine the playback preparation state for the KDM depending on whether the KDM has been distributed and using a valid period expiration time, and may determine the playback preparation state for the schedule SPL and time information of corresponding content.

The guide providing module may provide guidance that a corresponding DCP is mapped to a movie when the DCP preparation state is not completed, and may provide guidance so that the writing and distribution of the SPL are performed after the mapping.

Furthermore, the guide providing module may provide guidance so that the SPL for corresponding content is written when the SPL preparation state is not completed, and may continue to provide guidance until the SPL is distributed.

The theater management system may further include an equipment management unit configured to remotely control pieces of projection equipment provided in each theater.

The equipment management unit may include an emergency recovery module configured to restart projection from a playback stop time by automatically controlling power of the pieces of projection equipment according to a predetermined sequence if quality of the projection is a specific level or lower during the projection or the projection is stopped.

Furthermore, the equipment management unit may include an open processing module configured to automatically prepare the projection by applying power to the pieces of projection equipment provided in the theater according to a predetermined sequence at the start time or previously scheduled time of the theater and a closing processing module configured to automatically finish the projection by turning off the power of the pieces of projection equipment according to a predetermined sequence at the closing time or previously scheduled time of the theater.

Furthermore, the theater management system may further include a trial playback management unit configured to move to at least one point of the start, middle, end credits and end of content in response to a user manipulation and to perform the trial playback of the content.

Furthermore, the theater management system may further include a content management unit configured to perform at least one of the collection, distribution and group management of content.

The content management unit may include a content collection module configured to analyze information about content when the content is copied to a storage server and to automatically register the information, a DCP mapping module configured to map a DCP collected by the content collection module to a movie collected by the content collection module, an SPL writing module configured to automatically select a predefined SPL template based on the characteristics of the mapped DCP and to write an SPL, and a content distribution module configured to distribute content including the SPL and a DCP and KDM related to the SPL to a digital server of a corresponding theater based on distribution schedule information at once when the distribution schedule information of the written SPL.

Furthermore, the content management unit may further include a content group management module configured to perform at least one of a plurality of content batch searches, similar content searches and creation of a content group.

### Advantageous Effects

In accordance with an embodiment of the present invention, a user who does not have knowledge of projection can perform a projection operation because the TMS including a projection operation process automated and standardized so that a user who is unaware of projection can perform a projection operation.

Furthermore, the playback preparation state of the digital server provided in each theater is automatically determined and a guide for playback preparation completion is provided if the digital server has not been prepared for playback, so an operator can complete playback preparation.

Furthermore, projection can be automatically recovered if quality of the projection is deteriorated or the projection is stopped due to a problem of projection equipment or content during a projection operation.

Furthermore, projection can be prepared in line with the open time of a theater and projection can be terminated at a closing time.

Effects of the present invention are not limited to the aforementioned effects and may include various other effects within a range that is evident to a person having ordinary skill in the art from the following description.

### DESCRIPTION OF DRAWINGS

FIG. 1 is a diagram showing a system for managing content playback according to an embodiment of the present invention.

FIG. 2 is a block diagram schematically showing the configuration if a TMS according to an embodiment of the present invention.

FIG. 3 is a functional block diagram of a content management unit shown in FIG. 2.

FIG. 4 is an exemplary diagram of a content distribution schedule screen according to an embodiment of the present invention.

FIG. 5 is an exemplary diagram of a content distribution present-condition screen according to an embodiment of the present invention.

FIG. 6 is a functional block diagram of a playback preparation management unit shown in FIG. 2.

FIG. 7 is an exemplary diagram of a playback preparation check screen according to an embodiment of the present invention.

FIG. 8 is a screen for illustrating a playback preparation state according to an embodiment of the present invention.

FIG. 9 is a diagram for illustrating the meanings of playback preparation state icons according to an embodiment of the present invention.

FIG. 10 is an exemplary diagram of a DCP mapping screen according to an embodiment of the present invention.

FIG. 11 is an exemplary diagram of an SPL writing screen according to an embodiment of the present invention.

FIG. 12 is a functional block diagram of an equipment management unit shown in FIG. 2.

### DESCRIPTION OF REFERENCE NUMERALS

100: NOC system 200: TMS

210: content management unit

220: playback preparation management unit

230: equipment management unit

240: trial playback management unit

### MODE FOR INVENTION

The details of the objects and technological configurations of the present invention and corresponding acting effects will become more clearly understood from the following detailed description based on the drawings accompanied by the specification of the present invention.

Hereinafter, a “system for managing content playback” according to an embodiment of the present invention is described in detail with reference to the accompanying drawings. Embodiments to be described are provided in order for those skilled in the art to easily understand the technical spirit of the present invention, and the present invention is not restricted by the embodiments. Furthermore, contents represented in the accompanying drawings have been diagrammed in order to easily describe the embodiments of the present invention, and the contents may be different from drawing forms that are actually implemented.

Elements to be described herein are only examples for implementing the embodiments of the present invention. Accordingly, in other implementations of the present invention, different elements may be used without departing from the spirit and scope of the present invention. Furthermore, each of the elements may be purely implemented using a hardware or software element, but may be implemented using a combination of various hardware and software elements that perform the same function. Furthermore, two or more elements may be implemented together by a piece of hardware or software.

Furthermore, an expression that some elements are “included” is an expression of an “open type”, and the expression simply denotes that the corresponding elements are present, but should not be construed as excluding additional elements.

Content described hereinafter is a concept including a movie, music, game and animation, but is not limited thereto.

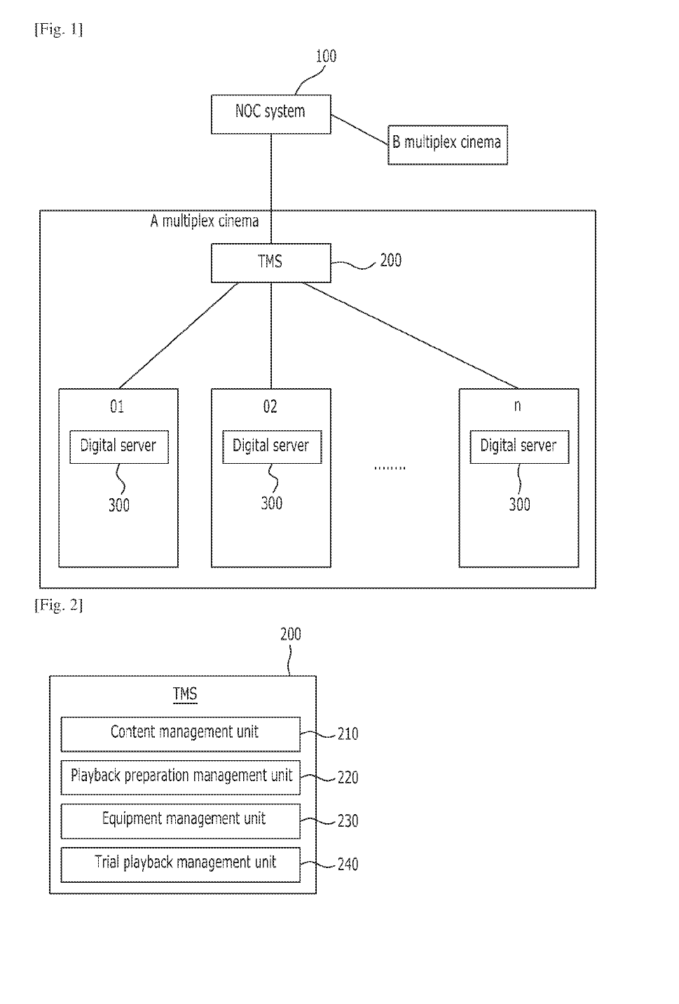

FIG. 1 is a diagram showing a system for managing content playback according to an embodiment of the present invention.

Referring to FIG. 1, the system for managing content playback includes a network operating center (NOC) system 100 and a theater system provided in each theater.

The NOC system 100 encrypts digital movie content and distributes the encrypted digital movie content to each theater system in the form of a digital cinema package (DCP).

The theater system receives encrypted movie content (DCP) and a key delivery message (KDM) including use permission information from the NOC system 100, decrypts the encrypted movie content, and plays back the movie content.

The theater system includes a digital server 300 provided in each theater and a theater management system (TMS) 200 for controlling the digital server 300. Furthermore, the theater system includes various types of equipment, such as a sound processor, audio, and a DLP (projector for projection) for movie playback, but a description thereof is omitted.

The digital server 300 is provided in each theater and plays back content according to a predetermined schedule.

The TMS 200 functions to automatically control pieces of equipment provided in a theater. Accordingly, the TMS 200 enables a user not having knowledge of projection to perform a projection operation.

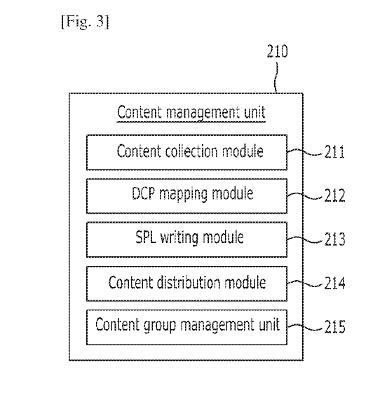

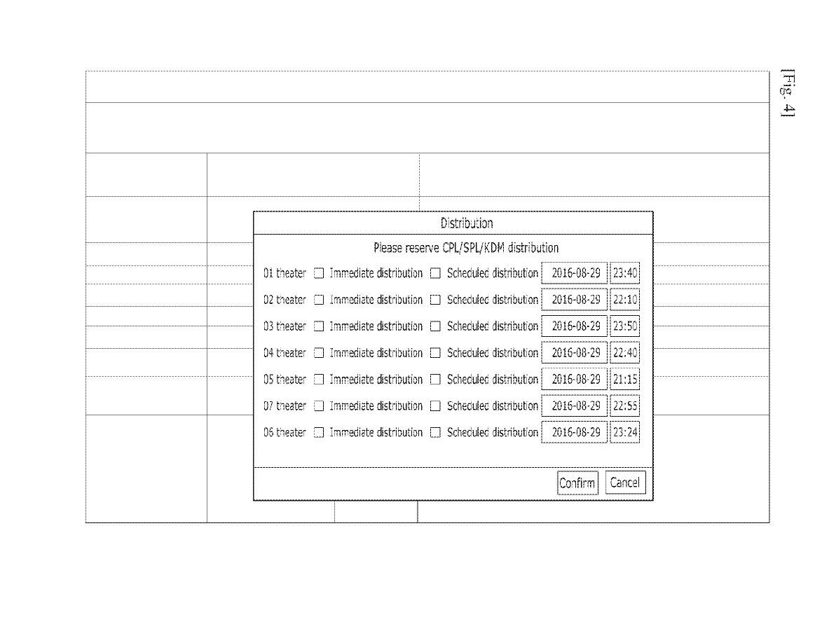

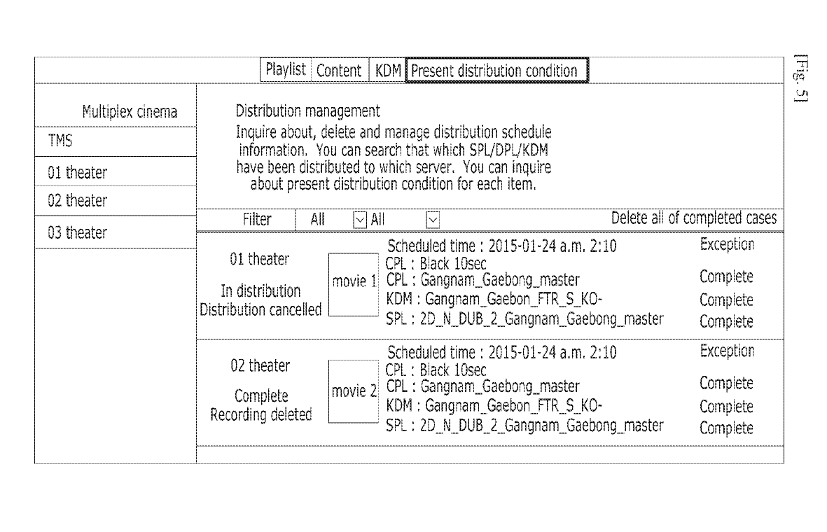

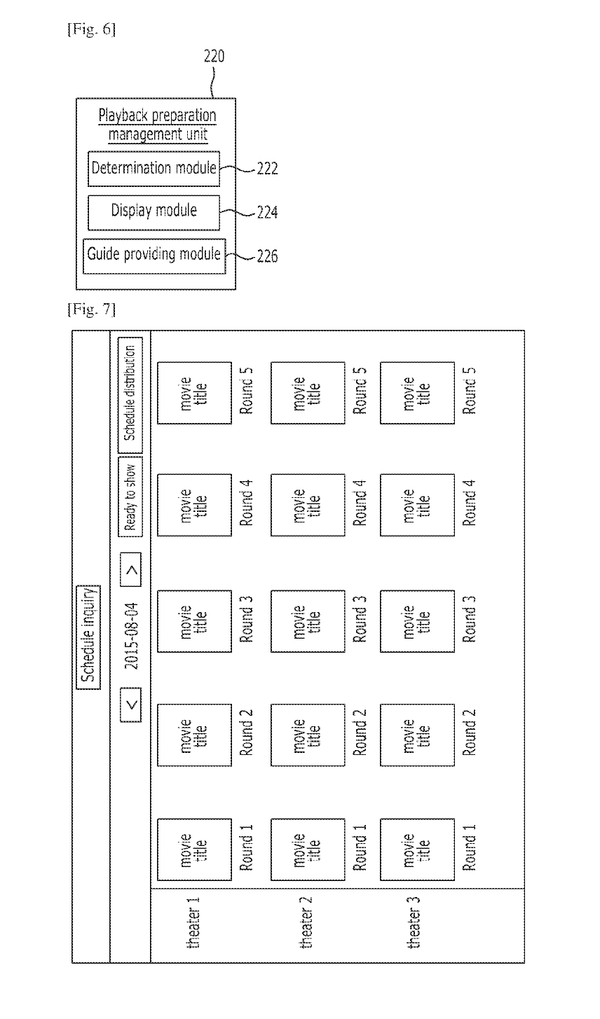

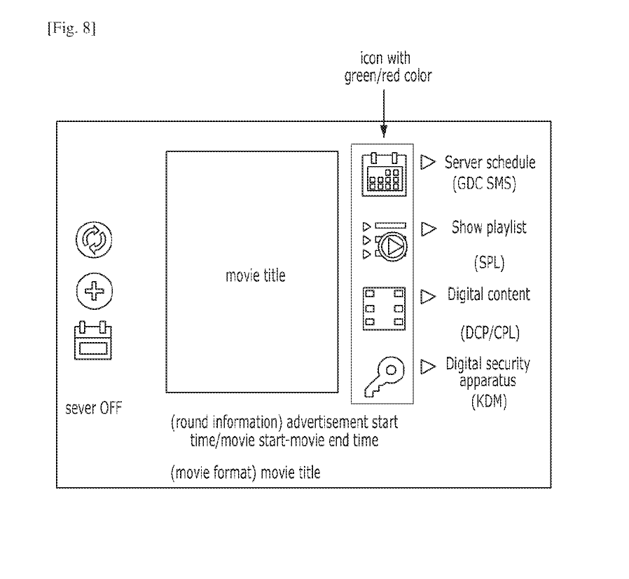

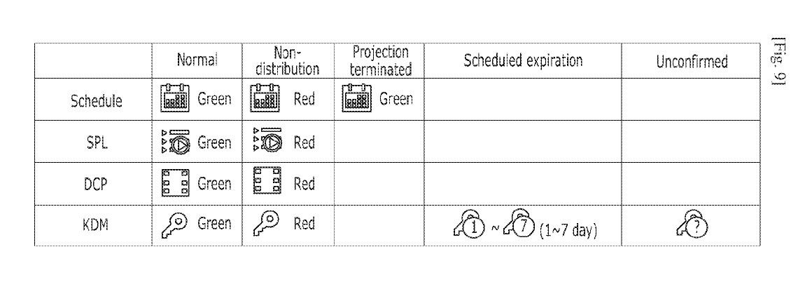

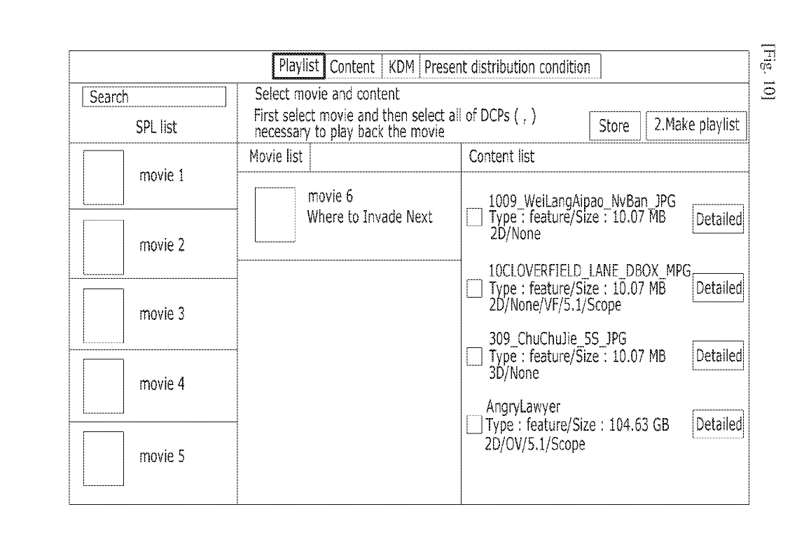

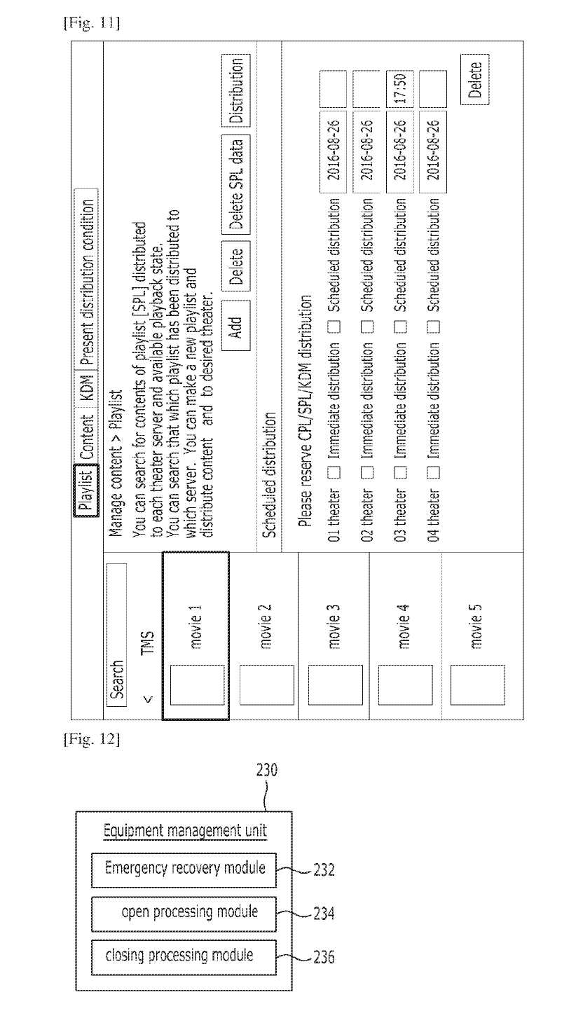

The TMS 200 is described in detail with reference to FIG. 2.

FIG. 2 is a block diagram schematically showing the configuration if a TMS according to an embodiment of the present invention. FIG. 3 is a functional block diagram of a content management unit shown in FIG. 2. FIG. 4 is an exemplary diagram of a content distribution schedule screen according to an embodiment of the present invention. FIG. 5 is an exemplary diagram of a content distribution present-condition screen according to an embodiment of the present invention. FIG. 6 is a functional block diagram of a playback preparation management unit shown in FIG. 2. FIG. 7 is an exemplary diagram of a playback preparation check screen according to an embodiment of the present invention. FIG. 8 is a screen for illustrating a playback preparation state according to an embodiment of the present invention. FIG. 9 is a diagram for illustrating the meanings of playback preparation state icons according to an embodiment of the present invention. FIG. 10 is an exemplary diagram of a DCP mapping screen according to an embodiment of the present invention. FIG. 11 is an exemplary diagram of an SPL writing screen according to an embodiment of the present invention. FIG. 12 is a functional block diagram of an equipment management unit shown in FIG. 2.

Referring to FIG. 2, the TMS 200 includes a content management unit 210, a playback preparation management unit 220, an equipment management unit 230 and a trial playback management unit 240.

The content management unit 210 performs at least one of the collection, distribution and group management of content. In this case, the content includes a digital cinema package (DCP), a key delivery message (KDM), an SPL and a schedule. The DCP may refer to a file containing the video/audio of a movie. The KDM may refer to an encrypted key file necessary to play back a DCP in the digital server. The SPL may refer to a file in which a DCP list (an advertisement and a movie) to be played back and a script on which a specific command predefined in the digital server is to be executed on a specific time have been defined. The schedule may refer to data in which the playback start time and movie name of a movie have been defined.

Referring to FIG. 3, the content management unit 210 includes a content collection module 211, a DCP mapping module 212, an SPL writing module 213 and a content distribution module 214.

The content collection module 211 analyzes content information when the content is copied to a storage server (not shown), and automatically registers the content information. That is, the content collection module 211 analyzes content information copied to the storage server through an external device or over a network, and automatically collects the content information. In this case, the content information may include information about the location of a DCP file, information about a CPL within the DCP, and meta information of a PKL file. Accordingly, a user's inconvenience to access the storage server through the content collection module 211 and to register content one by one can be obviated.

The DCP mapping module 212 maps a DCP, collected by the content collection module 211, onto a movie collected by the content collection module 211. That is, if a movie “A” has been organized in the schedule and the title of a DCP collected by the content collection module 211 is “B”, the movie “A” needs to be mapped onto the DCP “B.” in order to play the movie “A” back as the DCP “B.” For example, when a user selects a movie name “movie A” and a DCP name “Duckhye_FTR-3_S_KO-XX_KR-P2_51”, the DCP mapping module 212 maps the selected movie name onto the selected DCP.

The SPL writing module 213 automatically selects an SPL template previously configured according to the characteristics of content to be played back, and writes an SPL. That is, when a user selects a DCP for writing an SPL, the SPL writing module 213 determines the characteristics of the selected DCP, automatically selects an SPL template suitable for the determined characteristics, and provides the selected SPL template. The user writes an SPL in the provided SPL template. The characteristics of the DCP are classified into 2D, 3D, SCOPE and FLAT. A correct playback method, such as a change in a DLP channel, the cooperation of equipment for 3D, and control of the masking of a theater screen, is changed depending on each characteristic.

When distribution schedule information of an SPL is received, the content distribution module 214 distributes content, including the SPL and a DCP and KDM related to the SPL, to the digital server of a corresponding theater at once based on the distribution schedule information. The amount of content is very large, and content cannot be distributed while the content is played back. Accordingly, a content distribution is very important in a process of preparing movie playback and takes a lot of time. The content distribution module 214 provides a content schedule distribution function, that is, a function for providing a movie closing schedule time in each theater and previously scheduling a content distribution so that the content distribution can be scheduled at the earliest time.

When distribution schedule information of an SPL is received from a user, the content distribution module 214 distributes all of a DCP related to the selected SPL and a KDM in addition to the selected SPL. That is, when a user selects an SPL to be distributed and selects a content distribution schedule, a content distribution schedule screen, such as FIG. 4, is displayed. The user selects an immediate distribution or scheduled 265 distribution for each theater. When the user selects the scheduled distribution, he or she sets a distribution schedule time including a date and time. Accordingly, the content distribution module 214 distributes content, including an SPL corresponding to the set schedule time and a DCP and KDM related to the SPL, to the digital servers of corresponding theaters at once.

Furthermore, the content distribution module 214 provides a function for inquiring about, deleting and managing content distribution schedule information. When a user selects a distribution progress present-condition menu, the content distribution module 214 displays the present distribution condition indicating that which SPL/CPL/KDM has been distributed to which digital server, as shown in FIG. 5. Referring to FIG. 5, whether a distribution has been completed, such as during distribution and the completion of a distribution for each theater, a scheduled time, and the present distribution condition, such as a CPL, KDM and SPL, are displayed.

The content management unit 210 configured as described above may further include a content group management module 215 for performing at least one function of a plurality of content batch searches, similar content searches, the creation of a content group and reuse.

For movie playback, there is a need for a movie playback file for actual movie playback and advertisement content for advertisement playback. The contents and sequence of the advertisement content are frequently changed depending on factors, such as the type and playback time of a movie. A projection operator has to inconveniently modify an SPL including corresponding contents whenever the contents are changed. The SPL includes up to 30 DCPs including advertisement content and the name of content is not written in a natural language. Accordingly, it is not easy to select all of pieces of content suitable for a corresponding advertisement or movie and rearrange the sequence of the content. In order to solve the problem, the content group management module 215 provides a function for inquiring about a large amount of content at once and managing the content as a single group.

When a content list is received using a specific delimiter, the content group management module 215 searches for pieces of content corresponding to the received content list at once and displays the content. That is, when the content list to be searched for at once is received using a specific delimiter, the content group management module 215 searches for the pieces of content corresponding to the received content list at once and displays them. For example, if content A, B and C are required, a user inputs a content list to be searched for on a content search screen using a specific delimiter (e.g., ?, ″), such as “A, B, C.” In response thereto, the content group management module 215 searches for the received content A, B and C on the content search screen at once and displays the retrieved content. Furthermore, the content group management module 215 may search for similar content using only some contents of a content name.

Furthermore, the content group management module 215 may generate a plurality of pieces of content as a single group, and enables the generated content group to be used like one piece of content.

For example, it is assumed that in the case of advertisements, three advertisements A, B and C are used for movies A′, B′ and C′ in common, advertisements A, B and C+D are used for the movie A′, advertisements A, B and C+E are used for the movie B′, and advertisements A, B and C+F are used for the movie C′. In this case, a user designates the advertisements A, B and C, in common used by the movies A′, B′ and C′, as a “group a.” Accordingly, the “group a” is treated as one advertisement, and the user may reuse the “group a”, may apply it to several new movies, and may easily handle the group a when a new advertisement is changed or the sequence of advertisements is changed.

The playback preparation management unit 220 determines the playback preparation state of a digital server for each round, which is provided in each theater, and provides a guide for playback preparation completion when the digital server is a playback preparation incompletion state. In this case, the playback preparation state includes normal, non-distribution, playback end, scheduled expiration, and unconfirmed. In order for a movie to be played back, four elements, that is, a schedule (a specific movie and a specific time), an SPL, a digital cinema package (DCP) and a key delivery message (KDM), must have been distributed to each digital server. If an elements that belongs to the four elements and that has not been distributed is found, the playback preparation management unit 220 recognizes this as a playback preparation incomplete case, and provides guidance that which procedure will be taken next so that an operator can complete the playback preparation through the action.

Referring to FIG. 6, the playback preparation management unit 220 includes a determination module 222, a display module 224 and a guide providing module 226.

The determination module 222 determines the playback preparation state depending on whether an element including at least one of a schedule, an SPL, a DCP and a KDM has been distributed to a corresponding digital server. In this case, the determination module 222 determines the playback preparation state for the DCP and the SPL using a unique ID, determines the playback preparation state for the KDM depending on whether the KDM has been distributed and using a valid period expiration time, and determines the playback preparation state for the schedule using the SPL and time information of corresponding content.

That is, the determination module 222 inquires about whether the DCP for a content name is present in the corresponding digital server based on the unique ID of the DCP, and determines the playback preparation state for the DCP based on a result of the inquiry. Furthermore, the determination module 222 inquires about whether the SPL corresponding to the unique ID of the SPL has been distributed to the corresponding digital server, and determines the playback preparation state for the SPL based on a result of the inquiry. Furthermore, the determination module 222 determines whether the KDM has been distributed and the valid period expiration time, and determines the playback preparation state for the KDM based on a result of the determinations. The KDM is a method used by the DCP, if necessary. If the DCP itself is not required by the KDM, it is not necessary to determine whether the KDM has been distributed to a corresponding digital server. In the case of the DCP required by the KDM, the determination module 222 may determine whether the KDM has been distributed to a corresponding digital server and the valid period expiration time of the KDM, and may determine the playback preparation state for the KDM based on a result of the determinations. Furthermore, in the case of the schedule, the determination module 222 determines the preparation state for the schedule by determining whether the SPL and time information of corresponding content are identical with previously stored information. The schedule includes the title and start time data of a movie. The schedule of the digital server includes an SPL for playing back a movie and a start time when the SPL must be executed. Since a TMS already has information about an SPL suitable for the title of a movie, the determination module 222 may determine the preparation state for the schedule by determining whether an SPL and time information suitable for the corresponding movie are identical with previously stored information.

The display module 224 displays the playback preparation state for an element of each digital server for each round. That is, the display module 224 displays the playback preparation state for an element of each digital server for each round, determined by the determination module 222, in the form of a playback preparation check screen, such as FIG. 7. The playback preparation state of a digital server for each round of each theater is displayed on the playback preparation check screen. That is, the display module 224 displays the playback preparation state, as shown in FIG. 8. Icons with color (green, red, gray) displayed on the playback preparation check screen have the same meanings as those of FIG. 9.

The display module 224 displays the playback preparation state as normal, non-distribution or playback end in the case of the schedule, displays the playback preparation state as normal or non-distribution in the case of the SPL and the DCP, and displays the playback preparation state as normal, non-distribution, scheduled expiration or unconfirmed in the case of the KDM.

When an element in the playback preparation incompletion state is present, the guide providing module 226 provides a guide for the playback preparation completion of the corresponding element.

When the DCP preparation state is not completed, the guide providing module 226 provides guidance so that the DCP for corresponding content is mapped, and continues to provide guidance so that the writing and distribution of the SPL are performed after the mapping. That is, when the DCP preparation state is not completed, the guide providing module 226 displays a DCP mapping screen, such as FIG. 10. A user selects a movie in the DCP mapping screen and selects all of DCPs necessary to play back the movie. In response thereto, the guide providing module 226 maps the selected movie to the selected DCP and stores them. When the mapping of the movie and the DCP is completed, the guide providing module 226 displays an SPL writing screen, such as FIG. 11. The user writes an SPL in the SPL writing screen. The guide providing module 226 stores the written SPL. For a detailed description of a method for a user to write the SPL, reference is made to the description of the SPL writing module 215. When the writing of the SPL is completed, the guide providing module 226 displays an SPL distribution screen for distributing the written SPL. The user distributes the SPL through the SPL distribution screen.

Furthermore, when the SPL preparation state is not completed, the guide providing module 226 provides guidance that the SPL for corresponding content is written, and continues to provide guidance until the SPL is distributed. In the case of the schedule non-distribution state, the guide providing module 226 distributes the schedule. In the case of a movie start time mismatch or an SPL mismatch state, the guide providing module 226 performs a function for normalizing a schedule distribution state after redistributing a schedule after deleting a schedule that is a problem. In the case of the schedule non-distribution state, the guide providing module 226 may distribute a schedule for each theater, for each round or for all of rounds in all of theaters at once.

As described above, the playback preparation management unit 220 provides a function for checking whether all of elements necessary for projection have been prepared in one screen and providing notification of a next task to be performed if there is an element that has not been prepared so that playback preparation is completed.

The equipment management unit 230 remotely controls pieces of projection equipment provided in each theater. That is, the equipment management unit 230 remotely controls the projection equipment of a corresponding theater when at least one of a problem in projection equipment or content, the start time or previously scheduled time of a theater, and the closing time of a theater is generated during a projection operation. In this case, the pieces of projection equipment may include a sound processor, audio, a DLP (projector for projection) and a digital server, that is, elements for movie playback. Referring to FIG. 12, the equipment management unit 230 includes an emergency recovery module 232, an open processing module 234 and a closing processing module 236.

The emergency recovery module 232 restarts projection from a playback stop time by automatically controlling power of pieces of projection equipment according to a predetermined sequence if quality of projection is a specific level or lower during the projection or the projection is stopped. That is, if projection is suddenly stopped during a projection operation or projection needs to be played back again after the projection is stopped due to various problems (e.g., an equipment error), the emergency recovery module 232 provides a function for restarting projection from a playback stop time after turning off all of the pieces of projection equipment and then turning on them again according to a predetermined sequence. The pieces of projection equipment are characterized in that they can perform normal projection only when they are turned on according to a predetermined sequence and that related parts may be damaged if power of the projection equipment is suddenly off. Accordingly, the emergency recovery module 232 performs an operation of terminating the pieces of projection equipment according to a predetermined sequence while minimizing damage to the equipment so that normal projection can restart and turning on the equipment according to a predetermined sequence.

In order to control power of emergency recovery target equipment, a power distribution unit (PDU) capable of controlling power in response to a network command and a software power-off command provided by each piece of equipment are used in combination. Regarding equipment not damaged although corresponding power is immediately turned off, an immediate power-off command is transferred to a corresponding PDU. Regarding equipment expected to be damaged when corresponding power is immediately turned off, the software power-off command is first transferred to a DLP and digital server so that soft shutdown is performed. After the power is cut off using the PDU depending on the type of equipment, it is sequentially applied to the equipment again according to a predefined time so that the equipment is restarted.

The open processing module 234 automatically prepares projection by applying power to pieces of projection equipment provided in each theater according to a predetermined sequence at the start time or previously scheduled time of the theater. That is, the open processing module 234 provides a function for preparing projection by sequentially applying power to the pieces of projection equipment according to a predetermined sequence through corresponding PDUs when a theater starts its business or on a previously scheduled time. The pieces of projection equipment can perform normal projection only when they are powered on according to a predetermined sequence. Accordingly, time is set in the PDUs so that the pieces of projection equipment are turned on according to the predetermined sequence, and the open processing module 234 performs opening by transmitting a power-on command to each PDU. Furthermore, if an open time has been scheduled, the open processing module 234 performs opening by previously transmitting a power-on command to each PDU according to a predetermined sequence on a corresponding schedule time. For example, the open processing module 234 sequentially applies power to pieces of corresponding equipment by transmitting a power-on command in order of an SMS PDU, an amplifier PDU, an audio PDU and a DLP.

The closing processing module 236 automatically finishes projection by turning off power of the pieces of projection equipment according to a predetermined sequence at the closing time or previously scheduled time of a theater. That is, the closing processing module 236 provides a function for finishing projection by sequentially turning off power of the pieces of projection equipment according to a predetermined sequence through PDUs when a theater finishes its business. Regarding equipment not damaged although its power is immediately turned off, an immediate power-off command is transferred to a corresponding PDU. Regarding equipment expected to be damaged if its power is immediately turned off, a software power-off command is first transferred to a corresponding DLP and digital server so that soft shutdown is performed, and the power is turned off.

The trial playback management unit 240 moves to at least one point of the start, middle, end credits and end of content in response to a user manipulation, and performs trial playback. The trial playback refers to a task for previously playing back a movie to be played back today before business starts and checking whether a movie is normal. The trial playback refers to a process of checking the normal state of playback, the state of an image and titles, and the operating state of theater lightings at the time of the end credits and playback closing. The trial playback management unit 240 provides a function for rapidly moving to the start of a movie for the trial playback of the movie, to the middle point of a movie, to the end credits of a movie and to the closing point of a movie through a simple manipulation so that trial playback is rapidly completed.

Each of the content management unit 210, the playback preparation management unit 220, the equipment management unit 230 and the trial playback management unit 240 may be implemented in a computing device by a processor necessary to execute a program. As described above, the content management unit 210, the playback preparation management unit 220, the equipment management unit 230 and the trial playback management unit 240 may be implemented by physically independent elements, respectively, or may be implemented in a form in which they are functionally different in a single processor.

Each of the elements of the TMS 200 may be implemented in the form of a software module or hardware module executed by a processor or may be implemented in a form in which a software module and a hardware module have been combined. As described above, the software module or hardware module executed by a processor or the form in which a software module and a hardware module have been combined may be implemented as a hardware system (e.g., a computer system).

Furthermore, the TMS 200 is web-based software and may be used everywhere within a theater through mobile equipment. That is, the state of projection can be checked and handled everywhere within a theater through mobile equipment. Furthermore, the TMS 200 provides the best environment in which a user can support emergency recovery through his or her mobile equipment if the user has to receive a customer and process an accident and a user can process an accident by providing a manual for customer reception for each situation within a theater. Furthermore, a user can directly check the state of a theater using his or her mobile equipment while moving within the theater, and can perform trial playback. For example, when a movie is selected and starts, a user can check a DLP channel change, movie start and theater light off. When the movie moves to the middle of the movie, the user can check titles, an image and a sound. The user can check whether theater lights are half-turned on when the movie moves to the end credits and whether the theater lights are fully turned on when the movie is ended.

As described above, those skilled in the art to which the present invention pertains will appreciate that the present invention may be implemented in other detailed forms without changing the technical spirit or essential characteristic of the present invention. Accordingly, it is to be understood that the aforementioned embodiments are only illustrative, but are not limiting or restrictive. Furthermore, the flowcharts shown in the drawings are merely sequential order illustrated to achieve the most preferred results in implementing the present invention, and other additional steps may be provided or some of the steps may be deleted.

Technological characteristics described in this specification and an implementation for executing the technological characteristics may be implemented using a digital electronic circuit, may be implemented using computer software, firmware or hardware including the structure described in this specification and structural equivalents thereof, or may be implemented using a combination of one or more of them. Furthermore, the implementation for executing the technological characteristics described in this specification may be implemented using a computer program product, that is, a module regarding computer program instructions encoded on a kind of program storage media in order to control the operation of a processing system or for execution by the processing system.

In this specification, the term “system” or “server” includes all of devices, apparatuses and machines for processing data, in addition to a processor, a computer, a multi-processor and a computer, for example. The processing system may include, for example, code that forms processor firmware, a protocol stack, a database management system, an operating system, or all types of code that form an execution environment for a computer program when a combination of one or more of them is requested, in addition to hardware. A computer program also known as a program, software, a software application, a script or code may be written in any form of a programming language which includes a compiled or interpreted language or a transcendental and/or procedural language, and may also be implemented in any form including an independent program or module, a component, a subroutine or other units suitable for being used in a computer environment.

The elements that execute the technological characteristics of the present invention included in the block diagrams shown in the accompanying drawings of this specification mean a logical boundary between the elements. In accordance with software or hardware embodiments, however, the illustrated elements and functions thereof are executed in the form of an independent software module, a monolithic software structure, code, a service or a combination of them and are stored in a medium which is executable by a computer including a processor capable of executing stored program code and instructions to implement their functions. Accordingly, all of such embodiments should be construed as belonging to the scope of the present invention.

Accordingly, the accompanying drawings and technologies thereof describe the technical characteristics of the present invention, but should not be simply reasoned unless a specific array of software for implementing such technical characteristics is clearly described otherwise. That is, the aforementioned various embodiments may be present and may be partially modified while having the same technical characteristics as those of the present invention. Accordingly, such modified embodiments should be construed as belonging to the scope of the present invention.

Furthermore, the flowchart describes operations in the drawing in a specific sequence, but has been illustrated to obtain the most preferred results. It should not be understood that such operations must be executed or all the illustrated operations must be executed in the illustrated specific sequence or sequential order. In a specific case, multi-tasking and parallel processing may be advantageous. Furthermore, the separation of various system components in the aforementioned embodiments should not be construed as requesting such separation in all the embodiments. It should be understood that the aforementioned program components and systems may be integrated into a single software product or packaged into a multi-software product.

As described above, the detailed terms proposed in this specification are not intended to limit the present invention. Accordingly, although the present invention has been described in detail with reference to the aforementioned embodiments, those skilled in the art to which the present invention pertains may reconstruct, change and modify the embodiments without departing from the scope of the present invention. The scope of the present invention is defined by the appended claims rather than the detailed description, and the present invention should be construed as covering all modifications or variations derived from the meaning and scope of the appended claims and their equivalents.

1. A theater management system, comprising:
a playback preparation management unit configured to determine a playback preparation state of a digital server provided in each theater for each round and to provide a guide for playback preparation completion if the playback preparation state is a playback preparation incompletion state.

2. The theater management system of claim 1, wherein the playback preparation management unit comprises:
a determination module configured to determine the playback preparation state depending on whether an element comprising at least one of a schedule, an SPL, a digital cinema package (DCP) and a key delivery message (KDM) has been distributed to each digital server; and
a guide providing module configured to provide a guide for playback preparation completion of a corresponding element if the corresponding element is in the playback preparation incompletion state.

3. The theater management system of claim 2, further comprising a display module configured to display the playback preparation state for the element of each digital server for each round which has determined by the determination module.

4. The theater management system of claim 2, wherein the determination module determines the playback preparation state for the DCP and the SPL using a unique ID, determines the playback preparation state for the KDM depending on whether the KDM has been distributed and using a valid period expiration time, and determines the playback preparation state for the schedule SPL and time information of corresponding content.

5. The theater management system of claim 2, wherein the guide providing module provides guidance that a corresponding DCP is mapped to a movie where the DCP preparation state is not completed, and provides guidance so that a writing and distribution of the SPL are performed after the mapping.

6. The theater management system of claim 2, wherein the guide providing module provides guidance so that the SPL for corresponding content is written when the SPL preparation state is not completed, and continues to provide guidance until the SPL is distributed.

7. The theater management system of claim 1, further comprising an equipment management unit configured to remotely control pieces of projection equipment provided in each theater.

8. The theater management system of claim 7, wherein the equipment management unit comprises an emergency recovery module configured to restart projection from a playback stop time by automatically controlling power of the pieces of projection equipment according to a predetermined sequence if quality of the projection is a specific level or lower during the projection or the projection is stopped.

9. The theater management system of claim 8, wherein the equipment management unit comprises:
an open processing module configured to automatically prepare the projection by applying power to the pieces of projection equipment provided in the theater according to a predetermined sequence at a start time or previously scheduled time of the theater; and
a closing processing module configured to automatically finish the projection by turning off the power of the pieces of projection equipment according to a predetermined sequence at a closing time or previously scheduled time of the theater.

10. The theater management system of claim 1, further comprising a trial playback management unit configured to move to at least one point of a start, middle, end credits and end of content in response to a user manipulation and to perform trial playback of the content.

11. The theater management system of claim 1, further comprising a content management unit configured to perform at least one of a collection, distribution and group management of content.

12. The theater management system of claim 11, wherein the content management unit comprises:
a content collection module configured to analyze information about content when the content is copied to a storage server and to automatically register the information;
a DCP mapping module configured to map a DCP collected by the content collection module to a movie collected by the content collection module;
an SPL writing module configured to automatically select a predefined SPL template based on characteristics of the mapped DCP and to write an SPL; and
a content distribution module configured to distribute content comprising the SPL and a DCP and KDM related to the SPL to a digital server of a corresponding theater based on distribution schedule information at once when the distribution schedule information of the written SPL.

13. The theater management system of claim 12, wherein the content management unit further comprises a content group management nodule configured to perform at least one of a plurality of content batch searches, similar content searches and the creation of a content group.
